(19) United States
(12) Patent Application Publication
(10) Pub. No.: US 2004/0128614 A1
(43) Pub. Date: Jul. 1, 2004

(54) Real time internationalization of web pages with embedded server-side code

(75) Inventors: James Neal Andrews, Austin, TX (US); David Bruce Kumhyr, Austin, TX (US); Joseph C. Ross, Georgetown, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY (US)

(21) Appl. No.: 10/331,921

(22) Filed: Dec. 30, 2002

(51) Int. Cl. G06F 15/00

(52) U.S. Cl. 715/501.1; 715/513

(57) ABSTRACT

A method, computer program product, and data processing system for allowing real-time natural-language translation of web pages with embedded server-side code, such as is provided by JAVA SERVER PAGES (JSP) is disclosed. A pre-processor is utilized to identify portions of a web page that contain references to resource bundles used to store the text used in the web page. Where references to resource bundles are provided in a web page, additional input controls are added by the pre-processor to the web page to enable a translator to enter translated text. The translated text is then submitted back to the server that served the web page for inclusion in the resource bundle being used. In this way, a translator may translate a web-based application in real time without having to explicitly refer to the actual resource bundles being used.

### BACKGROUND OF THE INVENTION

1. Technical Field

The present invention is directed toward the internationalization of web pages with dynamic content. Specifically, the present invention is directed toward a system for translating dynamic content web pages in a real time fashion.

2. Description of Related Art

Since the introduction of the World Wide Web and the subsequent commercialization of the Internet, the world has become a considerably more connected place. No longer bound to the primitive communications interfaces of the past, the Internet is now host to a variety of powerful communications media, including interactive hypertext browsing (the World Wide Web), instant messaging, streaming video and audio, and multimedia electronic mail.

Hypertext is a method of organizing textual and graphical information on a computer screen. Information is organized into “pages,” which resemble printed pages in a book or (perhaps more accurately) printed scrolls (since a hypertext page can be of any length). The primary difference between hypertext and the printed word, however, lies in the fact that hypertext pages can contain links. That is, a portion of a hypertext document, such as a phrase or a graphic, may be made sensitive to clicking by the mouse such that when the user clicks on that portion, the user is directed to a new page or a different section of the current page. For instance, it is a common practice to make bibliographic citations into links. When a user clicks on one of these citations, the cited text appears on the screen. Hypertext documents are displayed using a program called a “browser.”

The largest and best-known repository of hypertext documents is the World Wide Web, a loosely bound collection of publicly accessible hypertext documents stored on computers the world over. The World Wide Web has become the preferred Internet medium for publishable information as well as for providing such interactive features as online shopping to the extent that the terms Internet and World Wide Web are virtually synonymous to some.

Browsers can download hypertext documents from a server with the HyperText Transfer Protocol (HTTP). HTTP allows a browser to request documents or files from a server and receive a response. In addition, when browser users enter information into a form embedded into a hypertext page, the browser transmits the information to a server using HTTP. Form information can then be passed along to applications residing on the server by way of the Common Gateway Interface (CGI). Those applications can then return a result, which may be written in HTML.

CGI-based applications (commonly referred to as CGI scripts) may also be used to display dynamic content, such as the contents of a database or other real-time data. CGI scripts that display dynamic data are cumbersome to write, however, because CGI requires that the dynamic content be formatted by the CGI script for output to “standard output” via primitive “print” or “write” statements.

One relatively recent innovation to alleviate this problem is the inclusion of embedded server-side code within web page documents. This innovation simplifies the creation of web pages to display dynamic web content, since web pages can be written using standard editors, just like static web pages. The program code necessary to gather and process the dynamic content is simply inserted into the web document source surrounded by special symbols or tags. When a page utilizing embedded server-side code is requested, a pre-processor evaluates the embedded program code and replaces the code within the document with the results of evaluating the program code. For example, an embedded code snippet to retrieve information from a database would be executed by the pre-processor to retrieve the information, then the portion of the web document source occupied by the embedded code snippet would be removed and replaced with the retrieved information before serving the web page to a client browser.

A number of systems to support embedded server-side code exist in the art, with different implementations supporting different languages and runtime environments. One particular embedded server-side code system is called JAVA SERVER PAGES (JSP). JSP supports the inclusion of embedded server-side code written in the JAVA language. JAVA is a trademark for a programming language created by Sun Microsystems, Inc. JAVA is an object-oriented, compiled, multi-threaded computer language that generates platform-independent executable code. JAVA is intended to make it possible to compile software once, but run on any machine supporting a JAVA Virtual Machine (JVM), which is essentially a software runtime environment for executing compiled JAVA code.

JAVA's “write once, run anywhere” philosophy extends not only into the realm of platform independence, but also to that of software internationalization, where a principle of “write once, run anywhere in the world” applies. JAVA was among the first computer language standards to embrace Unicode, a sixteen-bit character set standard that includes not only the twenty-six letters of modern English, but a variety of characters and accented characters used in other languages. The sixteen-bit standard allows a sufficient range of characters (65.536) not only for the inclusion of multiple alphabets, such as Cyrillic and Hebrew, but also for the character sets of languages such as Chinese and Japanese. Chinese does not use an alphabet but relies on the use of thousands of different ideograms; Japanese uses two alphabets in addition to a set of approximately two thousand ideograms.

JAVA also provides a facility for internationalization known as “Resource Bundles.” Resource bundles are files that store the text messages displayed by a JAVA program. When a JAVA program uses resource bundles, it loads its text messages from the resource bundle to be displayed to a user.

By separating text messages from the program code that displays them, it becomes easier to generate versions of a program that display in different languages. To make a German translation of an English original to a program, for instance, one need only create a German resource bundle to be interchanged with the English one. Thus, keeping to JAVA's “write once, run anywhere” philosophy, the JAVA program code need only be written and compiled once.

One particularly useful application of JAVA resource bundles is in the internationalization of web pages. JSP may be used to embed JAVA program code within a web page, where the JAVA program code accesses resource bundles to retrieve the text to be displayed within the web page. In this case, only the resource bundles need be translated in order to support different languages.

It is generally impractical for a software-producing organization, including an organization that produces web-based solutions, to employ a staff of translators for every language at every location in the organization where software is produced. A more practical approach, and one that is generally taken within the industry, is assign the responsibility for software translation to one or more translators in remote locations (often in other countries). In theory, a simple approach to software translation would be to send the resource bundles associated with a product to the translator, have the translator make new resource bundles containing translated text, then have the translator return the new resource bundles.

This approach is error prone, however. The translator, having only the text of the program to look at, is at a loss as to the context in which the text is used. When a translator is given no context in which to understand the text, the translator must make a guess as to which meaning is intended and choose a translation that matches the meaning. For instance, the English word “stop” may be translated into German as “halten,” “anhalten,” “aufhalten,” “aufhören,” “abstellen,” “einstellen,” or “stehenbleiben,” depending on the context. The best a translator can do, having only the word “stop” to translate into German, is to pick a likely candidate, for instance “halten.” Then, at some later time, the translator can view the completed product to check the context, make corrections to the appropriate resource bundle and return the corrected resource bundle to the software developers.

This is a rather involved process, especially considering the fact that many resource bundles may be utilized in a given product, and it may be difficult for a translator to pin down exactly which resource bundle or which portion of a resource bundle is being used at a given part of a web site or web application. Thus, what is needed is a way for translators to make immediate translations of web site text without having to refer to the underlying resource bundles or source code to make corrections.

### SUMMARY OF THE INVENTION

The present invention provides a method, computer program product, and data processing system for allowing real-time natural-language translation of web pages with embedded server-side code, such as is provided by JAVA SERVER PAGES (JSP). A pre-processor is utilized to identify portions of a web page that contain references to resource bundles used to store the text used in the web page. Where references to resource bundles are provided in a web page, additional input controls are added by the pre-processor to the web page to enable a translator to enter translated text. The translated text is then submitted back to the server that served the web page for inclusion in the resource bundle being used. In this way, a translator may translate a web-based application in real time without having to explicitly refer to the actual resource bundles being used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a networked data processing system in which the present invention may be implemented;

FIG. 2 is a block diagram of a server system within the networked data processing system of FIG. 1;

FIG. 3 is a block diagram of a client system within the networked data processing system of FIG. 1;

FIG. 4 is a diagram of a markup language source document in which embedded server-side code is included;

FIG. 5 is a diagram depicting a process of serving a web page containing embedded server-side code in accordance with a preferred embodiment of the present invention;

FIGS. 6A-6C are diagrams depicting modifications made to a source document in serving and pre-processing a source document in accordance with a preferred embodiment of the present invention;

FIG. 7 is a diagram depicting a process of real time translation in accordance with a preferred embodiment of the present invention;

FIG. 8 is a diagram of a web page in which an input control has been embedded in accordance with a preferred embodiment of the present invention;

FIG. 9 is a flowchart representation of a process of presenting a web page for real-time translation in accordance with a preferred embodiment of the present invention; and

FIG. 10 is a flowchart representation of a process of translating resource bundle text in real time in accordance with a preferred embodiment of the present invention.

### DETAILED DESCRIPTION OF THE PREFERRED EMBODIMENT

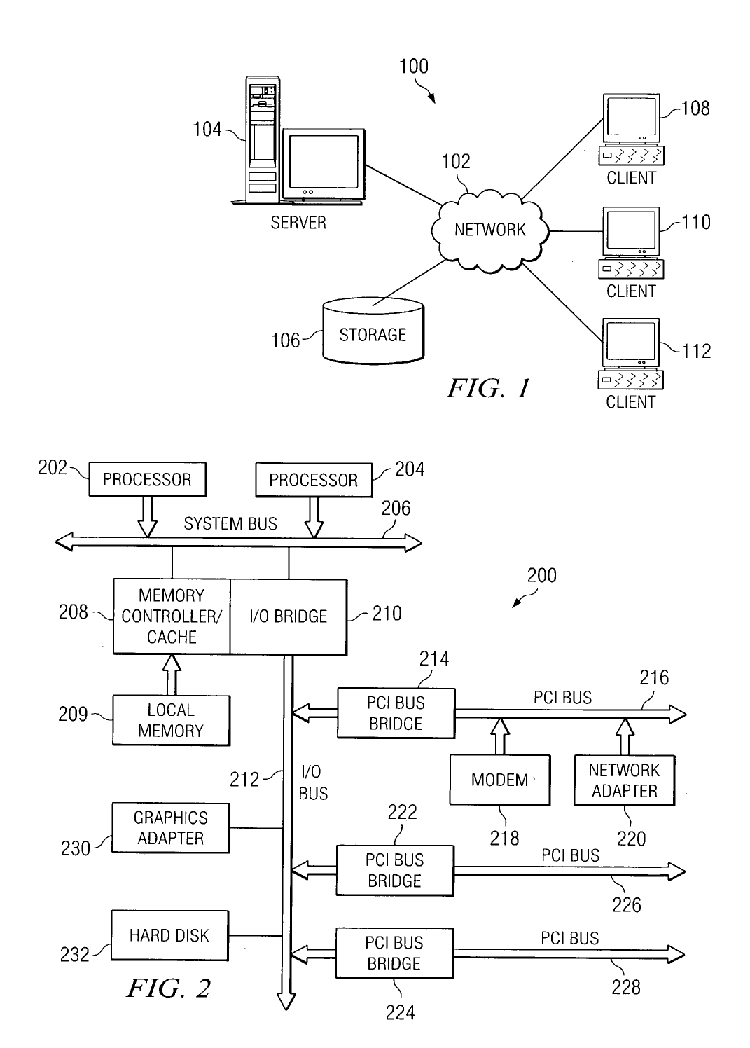

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N. Y., running the Advanced Interactive Executive (AIX) operating system or LINUX operating system.

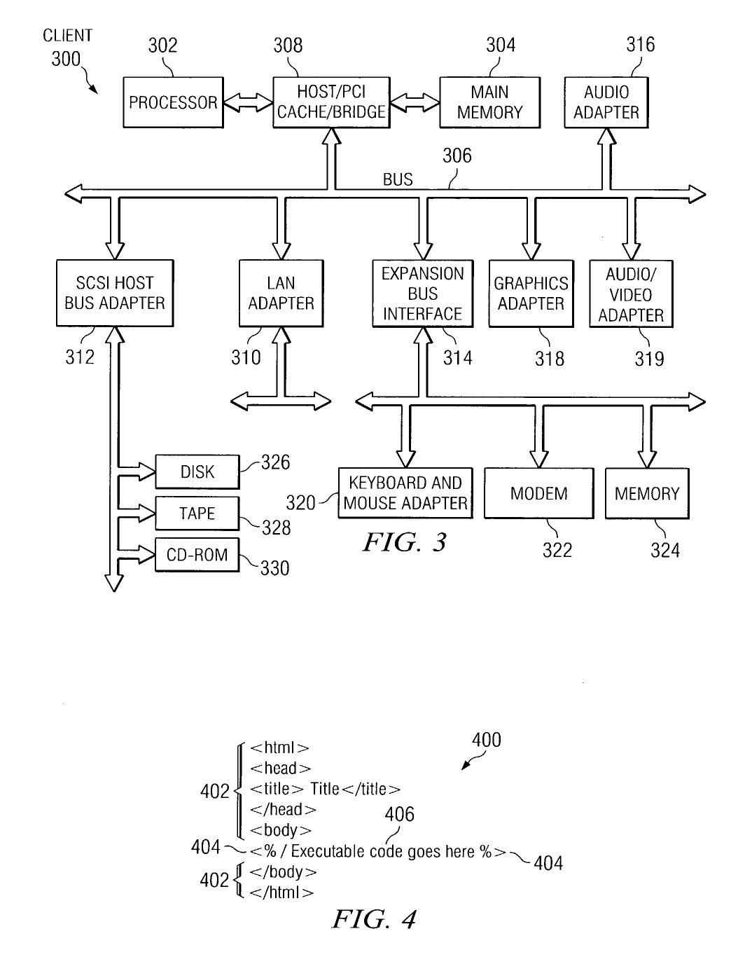

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

The present invention is directed toward the real-time translation of web pages using embedded server-side code. In particular, a preferred embodiment of the present invention utilized JAVA SERVER PAGES (JSP) coupled with JAVA Resource Bundles to facilitate internationalization of text messages. One of ordinary skill in the art will recognize that any number of embedded server-side code systems may be used in practice without departing from the scope and spirit of the present invention. Also, other mechanisms for internationalization of text message may be utilized other than JAVA Resource Bundles. The term “resource bundle,” as used herein, is intended to include JAVA resource bundles, but the term is also intended to have broad scope and encompass other forms of storage of textual elements, such as localization files, text databases, resource files, and the like.

FIG. 4 is a diagram of an HTML source file 400 in which embedded server-side code is included in accordance with a preferred embodiment of the present invention. FIG. 4 may be, for example, the source to a web document created using JAVA Server Pages (JSP). HTML source file 400 contains static content 402 comprising standard HTML tags. Static content 402 provides the bulk of the formatting for the web document represented by HTML source file 400.

Executable code in a language such as JAVA is included within special symbols 404, which in this example are a type of compound brackets (“<%” and “%>”) Executable code 406 is included between brackets 404. In this particular example, executable code 406 consists of only a comment, but in an actual embodiment executable code for producing dynamic content, such as retrieving information from a database, may be included. Also, executable code 406 could include a reference to a resource bundle to retrieve a text message for display in the web document represented by HTML source file 400.

When the web document represented by HTML source file 400 is served to a client browser, an interpreter (or just-in-time compiler) is used to execute executable code 406. Brackets 404 and embedded executable code 406 is then replaced with the output of executable code 406 and the resulting document is served to the client. In the case of a web page that utilizes resource bundles to achieve internationalization, executable code 406 would include code for accessing a text message stored in a resource bundle and outputting the text.

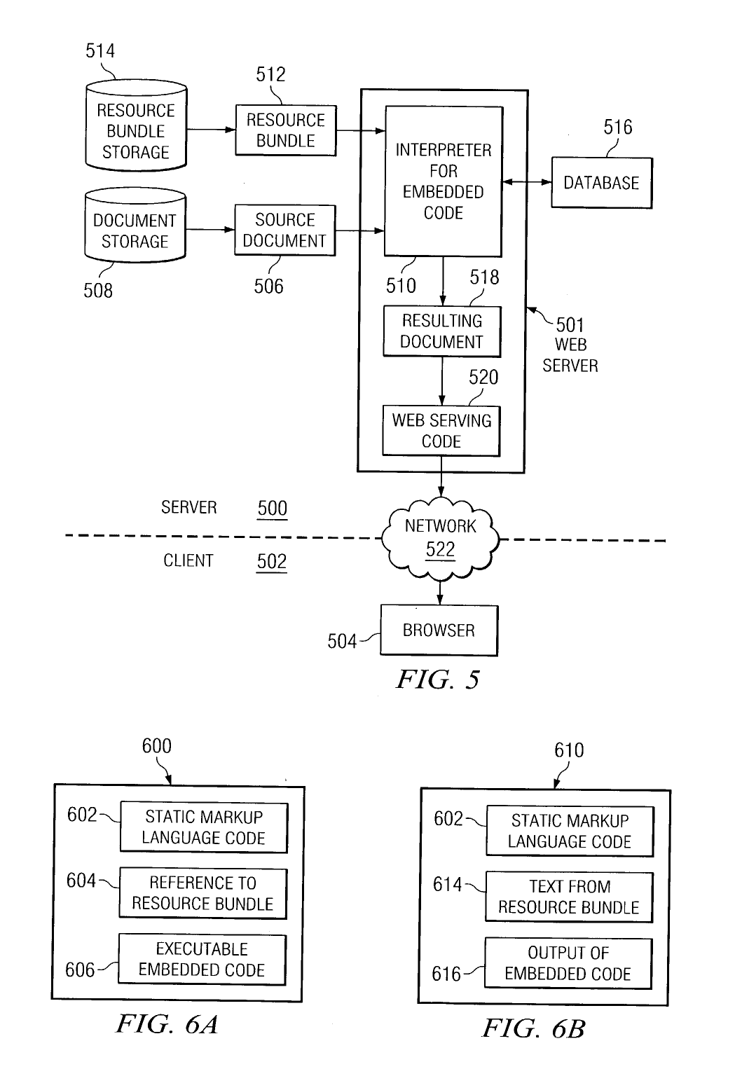

FIG. 5 is a diagram depicting a process of serving a web page with embedded code for displaying text contained in resource bundles in accordance with a preferred embodiment of the present invention. FIG. 5 is divided into two portions. The upper portion of the diagram represents a physical server (computer) 500 containing a (software) web server 501 for serving web pages with embedded server-side code. The lower portion of the diagram represents a client computer 502 operating browser software 504. Server 500 and client 502 communication through a network 522, which in a preferred embodiment may be the Internet.

Browser 504 submits a request for a particular web page to web server 501. Web server 501 retrieves HTML source 506 for the web page from web document storage 508. As source document 506 contains embedded server-side code, it is forwarded to an interpreter 510 associated with web server 510, which executes the embedded code. Since the embedded code contains references to text contained in resource bundles, one or more resource bundles 512 are retrieved by interpreter 510 from resource bundle storage 514 for use by the embedded code. Also interpreter 510 may access additional computing resources, such as a database 516 as required by the embedded code. For example, in a web page intended to display dynamic content, database 516 may be consulted in the process of executing the embedded server-side code contained in the web page.

After interpreter 510 completes execution of the embedded code, a resulting document 518 is produced and forwarded to web serving code 520 within web server 501 for transmitting resulting document 518 over network 522 to browser 504 residing on client 502.

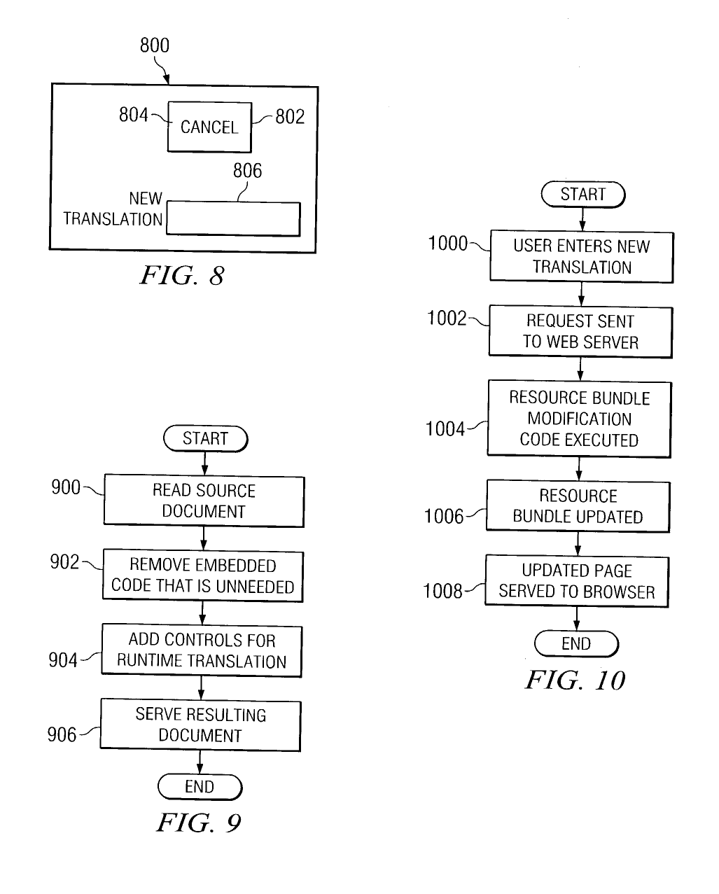

A preferred embodiment of the present invention allows for real time translation of web pages using embedded server-side code and resource bundles by embedding input controls into the resulting document that is served to the client browser. FIG. 8 is a diagram of a web page 800 in which an input control 806 has been embedded in accordance with a preferred embodiment of the present invention. Web page 800 is shown as it would be displayed within a web browser. In this example, a single feature within web page 800 contains translatable text. Button 802 contains the text message “Cancel” 804, which may be translated. Embedded input control 806 allows a translator to enter a translation for text message 804. In this example, input control 806 is a text field in which a translator may enter a translation text and press “enter” or “return” on the computer keyboard to submit the translation. Once the translation has been submitted for entry, the resource bundle containing text message 804 is modified to include the new translation in place of the original text, and web page 800 may be redisplayed with the new translated text in place.

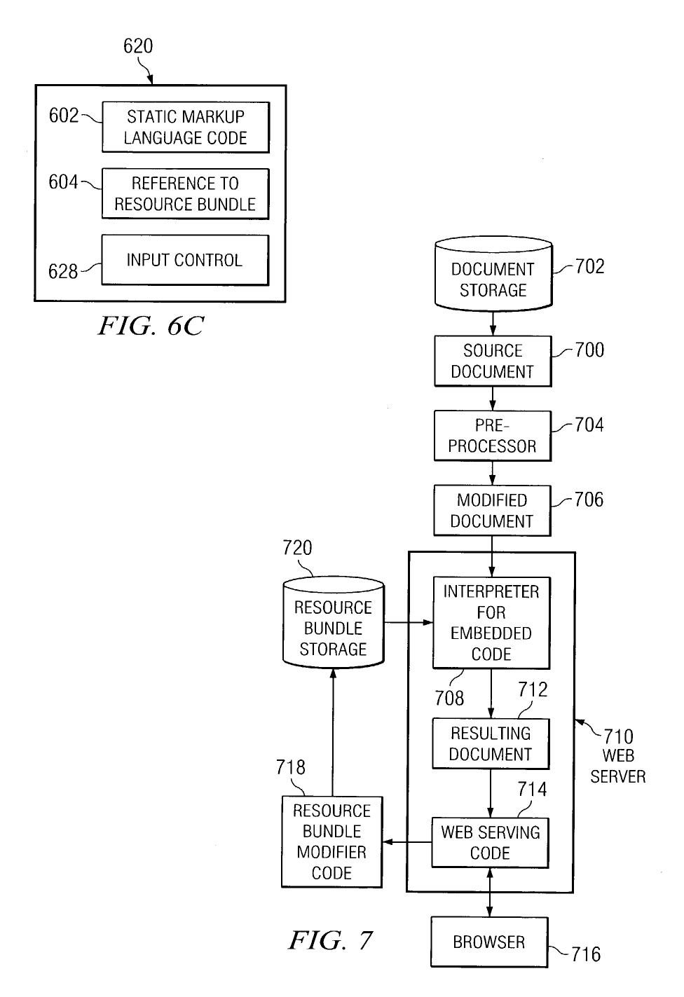

Insertion of the input control in a preferred embodiment of the present invention is achieved by applying a pre-processor to the source document to modify the document prior to submission to an embedded code interpreter or web server. FIGS. 6A-6C are diagrams that illustrate the modifications made to a source document during normal serving of the document and when modified to include an input control in accordance with a preferred embodiment of the present invention.

FIG. 6A represents an unmodified source document 600 containing embedded server-side code. Source document 600 include static features 602 in a markup language such as HTML. Embedded server-side code containing a reference to a resource bundle 604 is also included. Finally, additional embedded server-side code 606 is included for performing other tasks, such as providing dynamic content.

FIG. 6B represents a resulting document 610 obtained through normal serving of source document 600. Static features 602 remain unchanged, as one would expect. Resource bundle reference 604 is replaced by the corresponding text from the correct resource bundle 614. Embedded code 606 is also replaced by output 616 of embedded code 606.

FIG. 6C is a diagram depicting a modified version 620 of pre-processing source document 600 in FIG. 6A in accordance with a preferred embodiment of the present invention. Static markup code 602 remains unchanged, as does resource bundle reference 604, as pre-processed modified document 620 has not yet been submitted to an interpreter or just-in-time compiled for execution of the embedded code. Embedded code 606 has been eliminated from modified document 620 to disable dynamic content features that are not necessary to text translation. An input control 628 has been inserted within modified document 620 for modifying the text referred to in resource bundle reference 604. When a translator submits a translation text to the web server using input control 628, the appropriate resource bundle will be updated with the new translation. Input control 628 may, in a preferred embodiment, comprise a simple control, as would be used to communicate with a CGI script, or may also include browser-side scripting code (implemented in a client-side scripting language, such as JavaScript).

FIG. 7 is a diagram depicting a process of real time translation in accordance with a preferred embodiment of the present invention. In FIG. 7, the distinctions between the server computer and client computer have been eliminated to demonstrate that the web server software and browser software may either reside on separate computers or on the same computer in an actual embodiment of the present invention.

In response to browser 716's request for a web page, web server 710 retrieves a source document 700 from document storage 702 and submits source document 700 to a pre-processor 704. Pre-processor embeds input control(s) in source document 700 and optionally strips out additional embedded code that is not needed for the translation process, resulting a modified document 706.

Modified document 706 is then submitted to interpreter 708 for processing the embedded code within modified document 706 for accessing the appropriate resource bundle(s). Interpreter 708 retrieves the appropriate resource bundle(s) from resource bundle storage 720 and replaces the embedded code containing resource bundle references with the appropriate text, resulting in resulting document 712. Resulting document 712 is submitted to web serving code 714, which serves resulting document 712 to browser 716.

A translator operating browser 716 may then submit translated text using the embedded input control(s). In a preferred embodiment, the translated text is submitted to web server 710 in the manner normally used for CGI scripts. One of ordinary skill in the art will recognize, however, that different forms of network or inter-process communication may be utilized in place of the conventional HTTP/CGI submission technique without departing from the scope and spirit of the present invention. In any case, the translated text is communicated to resource bundle modifier code 718, which accesses the appropriate resource bundle within resource bundle storage 720 and replaces the appropriate text with its translation. Resource bundle modifier code 718 may also direct web server 710 to reserve the translated page with its new translation for display in browser 716 for the translator.

FIG. 9 is a flowchart representation of a process of presenting a web page for real-time translation in accordance with a preferred embodiment of the present invention. A source document containing embedded server-side code accessing resource bundles is read from storage (block 900). Any unneeded embedded code or embedded code that is unwanted during the translation process, such as code that accesses external computing resources like databases, is removed from the source document (block 902). Input controls are added to the document that allow for input of translated text corresponding to resource bundle references (block 904). Finally, the resulting document is served to the client browser for translation (block 906).

FIG. 10 is a flowchart representation of a process of translating resource bundle text in real time in accordance with a preferred embodiment of the present invention. A user (i.e., translator) presented with a web page containing an embedded input control for entering a translation, enters a new translation for resource bundle-derived text (block 1000). The new translation is submitted to the web server as a request or form submission (block 1002). The web server submits the request to resource bundle modification code (block 1004). The resource bundle modification code updates the correct resource bundle to include the translation (block 1006). Finally, the translated page is served to the user's web browser (block 1008).

It is important to note that while the present invention has been described in the context of a fully functioning data processing system, those of ordinary skill in the art will appreciate that the processes of the present invention are capable of being distributed in the form of a computer readable medium of instructions or other functional descriptive material and in a variety of other forms and that the present invention is equally applicable regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system. Functional descriptive material is information that imparts functionality to a machine. Functional descriptive material includes, but is not limited to, computer programs, instructions, rules, facts, definitions of computable functions, objects, and data structures.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method comprising:
reading a document in a markup language having an embedded reference to text contained in a resource file;
inserting an input control into the document, wherein the input control is a prompt for modifying the text referred to by the embedded reference; and
serving the document to a browser for display.

2. The method of claim 1, further comprising:
inserting embedded code into the document, wherein the embedded code enables the text referred to by the embedded reference to be modified in response to user input directed at the input control.

3. The method of claim 2, wherein modifying the text includes displaying modified text by the browser in place of the text as originally displayed.

4. The method of claim 2, wherein modifying the text includes modifying the resource file.

5. The method of claim 1, further comprising:
locating embedded code within the document, wherein the embedded code contains references to external computing resources; and
removing the embedded code from the document.

6. The method of claim 5, further comprising:
replacing the embedded code with placeholder data.

7. A computer program product in a computer-readable medium, comprising functional descriptive material that, when executed by a computer, enables the computer to perform acts including:
reading a document in a markup language having an embedded reference to text contained in a resource file;
inserting an input control into the document, wherein the input control is a prompt for modifying the text referred to by the embedded reference; and
serving the document to a browser for display.

8. The computer program product of claim 7, comprising additional functional descriptive material that, when executed by the computer, enables the computer to perform additional acts including:
inserting embedded code into the document, wherein the embedded code enables the text referred to by the embedded reference to be modified in response to user input directed at the input control.

9. The computer program product of claim 8, wherein modifying the text includes displaying modified text by the browser in place of the text as originally displayed.

10. The computer program product of claim 8, wherein modifying the text includes modifying the resource file.

11. The computer program product of claim 7, comprising additional functional descriptive material that, when executed by the computer, enables the computer to perform additional acts including:
locating embedded code within the document, wherein the embedded code contains references to external computing resources; and
removing the embedded code from the document.

12. The computer program product of claim 11, further comprising:
replacing the embedded code with placeholder data.

13. A data processing system comprising:
means for reading a document in a markup language having an embedded reference to text contained in a resource file;
means for inserting an input control into the document, wherein the input control is a prompt for modifying the text referred to by the embedded reference; and
means for serving the document to a browser for display.

14. The data processing system of claim 13, further comprising:
means for inserting embedded code into the document, wherein the embedded code enables the text referred to by the embedded reference to be modified in response to user input directed at the input control.

15. The data processing system of claim 14, wherein modifying the text includes displaying modified text by the browser in place of the text as originally displayed.

16. The data processing system of claim 14, wherein modifying the text includes modifying the resource file.

17. The data processing system of claim 13, further comprising:
means for locating embedded code within the document, wherein the embedded code contains references to external computing resources; and
removing the embedded code from the document.

18. The data processing system of claim 17, further comprising:
means for replacing the embedded code with placeholder data.
